(19) United States
(12) Patent Application Publication
(10) Pub. No.: US 2007/0159858 A1
(43) Pub. Date: Jul. 12, 2007

(54) Bi-directional energy conversion system

(76) Inventors: Leonid Spindler, Hertzl (IL); Aharon Agizim, Netanya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/571,050

(22) PCT Filed: Apr. 21, 2005
(86) PCT No.: PCT/IL05/00438

§ 371 Date: Dec. 21, 2006

Related U.S. Application Data
(60) Provisional application No. 60/585,830, filed on Jul. 8, 2004.

(51) Int. Cl. H02M 5/45

(52) U.S. Cl. 363/37

(57) ABSTRACT

An alternating current (AC) to direct current (DC) high efficiency conversion architecture comprises an AC-to-DC conversion input stage operative to receive an instantaneous AC input, a DC output stage connected to the input stage through an AC link and operative to output a DC power to at least one customer, and an energy storage device used as an energy balancer between the changing power availability at the instantaneous AC input and the constant power requirements of the at least one customer, the energy storage device coupled to both input and output stages stage through the AC link.

### FIELD OF THE INVENTION

The present invention relates to power conversion architectures or topologies (used herein interchangeably), and in particular to alternating current (AC) to direct current (DC) or AC/DC conversion architectures used in power supplies.

### BACKGROUND OF THE INVENTION

Power supplies represent a very important product in a field that may be defined generally as the power conversion field. Various power conversion topologies are known in the art. A traditional industry standard AC-to-DC conversion topology or architecture 100 is shown in FIG. 1. Architecture 100 comprises an input stage 102 that receives an AC input from a line mains, stage 102 connected to an energy storage component (e.g. a bulk capacitor) 104, which in turn is connected to an output stage 106 that has at least one DC output. Input stage 102 is connected to energy storage component 104 through a first (input) uni-directional energy carrying link 108′. Output stage 106 is connected to energy storage component 104 through a second (output) uni-directional energy carrying link 108″. Thus, component 104 is coupled to both the input and the output stages. The input to link 108′ is a rough DC input, while the output to stage 106 from component 104 is a more refined DC output (carried in link 108″). To clarify, output stage 106 is a DC-to-DC converter stage. Links 110′ and 110″ close the electrical circuits between stage 102 and component 104 and stage 106 and component 104 respectively. A control module 120 communicates electrically, in a wired or wireless way, with each of the elements 102, 104 and 106. The communication is generally bi-directional (transmitting instructions to the elements and receiving information from the elements), except that the communication with the energy storage component may be unidirectional (for only receiving information from component 104).

In use, an AC input universal line voltage (e.g. 84-260 VAC, 50-60 Hz) is input to stage 102 and is converted therein into a rough (discontinuous) DC current. The rough DC current exits stage 102 through link 108′ and is input to energy storage component (i.e. bulk capacitor) 104. The main function of bulk capacitor 104 is to implement a buffer for the discontinuous DC current (and corresponding energy) and to ensure a steady input to stage 106. Capacitor 104 handles all the energy incoming from stage 102. The DC current then exits capacitor 104 and is transferred to output stage 106 through link 108″. In stage 106, the current undergoes further DC-to-DC conversion as needed and is output through the at least one output to a customer connected to the output.

A more detailed view of a prior art system as described above is shown in FIG. 2. FIG. 2 shows a prior art architecture 200, in which input stage 102 of FIG. 1 is embodied by an input full wave rectifier (AC-to-DC) 202 electrically coupled to a DC/DC power factor correction (PFC) module 204. The PFC module is generally a separate unit. Energy storage component 104 is embodied by a bulk capacitor 206, and links 108′, 108″ and 110′, 110″ are embodied respectively by arrows 208′ and 208″. Output stage 106 is embodied by at least one output DC-to-AC converter 210 coupled to at least one output AC-to-DC converter 212, from which a final power output exits at an output “Out 1”. Optionally, additional sets of DC-to-AC converters coupled to AC-to-DC converters (e.g. 214 and 216) can be connected to and supplied from “Out 1”. The control module (120 in FIG. 1) exists here as well but is not shown.

The traditional prior art architecture embodied in FIGS. 1 and 2 forces many serial AC/DC and DC/AC power conversions (up to 6 sections in FIG. 2) This results in a number of significant disadvantages including the need for multiple conversion topologies per section that result in multiple conversion frequencies, extra power losses per section, complicated electromagnetic (EM) interference problems, and the need to have a high voltage bulk storage capacitor on the primary.

There is therefore a widely recognized need for, and it would be highly advantageous to have a power conversion architecture that does not suffer from these disadvantages.

### SUMMARY OF THE INVENTION

The present invention discloses a new power conversion architecture and topology based on an AC coupled bi-directional energy flow that allows parallel conversions with feed forward and feedback links. The architecture and topology are incorporated in a conversion system also referred to as a “Bi-directional Energy Conversion System” or BECS.

The architectures and topologies disclosed herein provide a number of significant advantages: they allow optimization of the total power supply performance, have common soft switching conversion sections, and allow the use of any voltage bulk capacitor or quick charge/discharge battery on the secondary. Advantageously, the disclosed topologies remove the need for a high voltage capacitor on the primary

In a preferred embodiment, the conversion architecture of the present invention comprises an input stage which includes an AC-to-DC input rectifier coupled to a DC to AC converter (DC-to-AC inverter), a DC output stage directly coupled to the input stage through an AC link, and an energy storage device used as an energy balancer between a changing power availability at the input stage and the constant power requirements of an output load at the output stage. The energy storage device includes a bidirectional AC<>DC inverter/converter and an energy storage component (capacitor or quick charge/discharge battery), and, advantageously and in contrast with the situation in existing conversion system, is connected to the input and output stages through the AC link. When the input power is less than the required output power, the energy storage device is coupled only to the DC output stage. When the input power is equal to the power requirements at the Dc output, the architecture enables a direct transfer of all power exiting the input stage to the output stage in an AC form. When the input power is greater than the required output power, the energy storage device receives the excess power from the input stage. The architecture thus provides much higher overall conversion efficiency, and maintains power factor correction industry requirements. The topology is suitable also for un-interruptable power supplies and motor control systems.

In a preferred embodiment, the conversion architecture further comprises a control unit coupled to the input stage, to one or more DC output stages and to the energy storage device in order to insure both the existence of power factor requirements, and to insure the stability of the output voltage(s).

According to the present invention, there is provided an AC-to-DC high efficiency conversion architecture comprising an input stage operative to receive an AC input from (e.g. from a line mains) and to output a high frequency (HF) AC output, a DC output stage operative to receive the HF AC output through an AC link and to output a DC power to at least one customer through a respective DC output, and an energy storage device used as an energy balancer between a changing power availability at the input stage and a constant power requirement of the at least one customer, the energy storage device operative to interact with both the input and output stages through the AC link, whereby the architecture enables a direct transfer of all power exiting the input stage to the output stage in an AC form, thereby providing a much higher overall conversion efficiency. In a preferred embodiment, the architecture further comprises a control unit coupled to the input stage, to the DC output stage and to the energy storage device and used for power factor correction, energy balancing for efficiency optimization, and for regulation of the DC output.

According to one feature in the conversion architecture of the present invention, the input stage includes an electromagnetic interference (EMI) filter coupled electrically to an input full wave AC-to-DC rectifier, the rectifier further coupled electrically to a DC-to-AC inverter.

According to another feature in the conversion architecture of the present invention, the energy storage device includes a bi-directional AC<>DC inverter/converter and an energy storage component.

According to yet another feature in the conversion architecture of the present invention, the energy storage component is selected from the group consisting of a capacitor and a quick charge/discharge battery.

According to yet another feature in the conversion architecture of the present invention, the DC output stage includes a plurality of regulators, which may be either synchronous or asynchronous rectifiers/regulators, connected in parallel to the AC link, each regulator connected to a respective customer.

According to yet another feature in the conversion architecture of the present invention, the coupling of the energy storage device to the AC input stage is unidirectional from the input stage to the energy storage device.

According to the present invention, there is provided an AC-to-DC high efficiency conversion topology comprising an input stage coupled to a DC output stage through an AC bus, an energy balancer operatively coupled to the input and DC output stages through the AC bus and operative to regulate power allocation and transfer between an instantaneous AC power input to the input stage and a converted DC power output to a customer at the output stage, and a control unit coupled to the input stage, to the DC output stage and to the energy balancer and used for controlling the operation of the input and output stages and the energy balancer.

According to one feature in the conversion topology of the present invention, the input stage includes an EMI filter coupled electrically to an input full wave AC-to-DC rectifier, the rectifier further coupled electrically to a DC-to-AC inverter.

According to another feature in the conversion topology of the present invention, the energy balancer includes a bi-directional AC<>DC inverter/converter coupled bi-directionally to an energy storage component.

According to yet another feature in the conversion topology of the present invention, the energy storage component is selected from the group consisting of a capacitor and a quick charge/discharge battery.

According to yet another feature in the conversion topology of the present invention, the DC output stage includes a plurality of regulators connected in parallel to the AC bus, each regulator connected to a respective customer.

According to yet another feature in the conversion topology of the present invention, the coupling of the energy balancer to the input stage is unidirectional from the AC input stage to the energy balancer.

According to the present invention, there is provided a method for efficient conversion of AC power to DC power, comprising the steps of inputting an instantaneous AC power to an input stage that is operative to output an HF AC voltage, transferring the HF AC voltage through an AC link to a DC output stage that is operative to output a required DC power to at least one customer, and using an energy storage device coupled to both the input stage and the DC output stage through the AC link to correct any imbalance between the required DC power and the instantaneous AC power

According to one feature in the method of the present invention, the step of using an energy storage device to correct any imbalance includes having the energy storage device supply power to the DC output stage when the input power is smaller than the required DC power.

According to another feature in the method of the present invention, the step of using an energy storage device to correct any imbalance includes having the energy storage device allow a direct transfer of all power exiting the input stage to the output stage in an AC form when the input power is equal to the required DC power.

According to yet another feature in the method of the present invention, the step of using an energy storage device to correct any imbalance includes having the energy storage device receive excess power from the input stage when the input power is greater than the required DC power.

According to the present invention there is provided in an AC-to-DC converter, a power factor correction subsystem comprising an input stage operative to receive an instantaneous AC power and to output an HF AC voltage, and an energy storage device coupled to the input stage through an AC bus and operative to regulate power allocation and transfer between an instantaneous AC power input to the input stage and a converted DC power output to a customer at an output stage, whereby the power factor correction in the AC-to-DC converter is performed using the AC bus.

According to one feature in the PFC sub-system of the present invention, the input stage includes an EMI filter coupled electrically to an input full wave AC-to-DC rectifier, the rectifier further coupled electrically to a DC-to-AC inverter.

According to another feature in the PFC sub-system of the present invention, the energy storage device includes a bidirectional AC<>DC inverter/converter and an energy storage component.

### BRIEF DESCRIPTION OF THE DRAWINGS

Reference will be made in detail to preferred embodiments of the invention, examples of which may be illustrated in the accompanying figures. The figures are intended to be illustrative, not limiting. Although the invention is generally described in the context of these preferred embodiments, it should be understood that it is not intended to limit the spirit and scope of the invention to these particular embodiments. The structure, operation, and advantages of the present preferred embodiment of the invention will become further apparent upon consideration of the following description, taken in conjunction with the accompanying figures, wherein:

FIG. 1 shows a commonly used prior art power conversion architecture;

FIG. 2 shows details of a prior art power conversion architecture;

FIG. 3 shows a basic block diagram of the power conversion architecture of the present invention;

FIG. 4 shows details of the power conversion architecture of the present invention;

FIG. 5 shows a detailed circuit implementation of the architecture of FIG. 4

### DETAILED DESCRIPTION OF THE PREFERRED EMBODIMENTS

The present invention discloses a new power conversion architecture (topology) based on a bi-directional energy flow that allows parallel conversions with feed forward and feedback links.

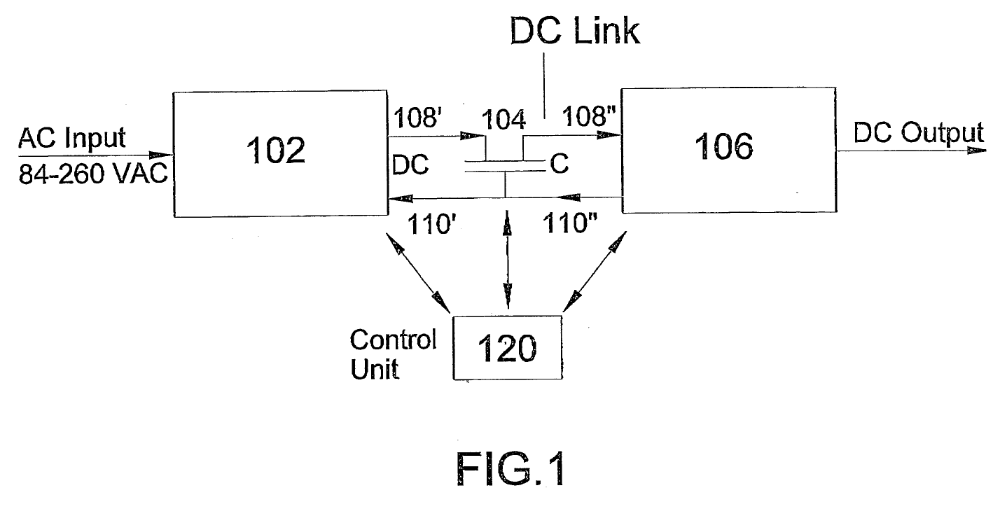

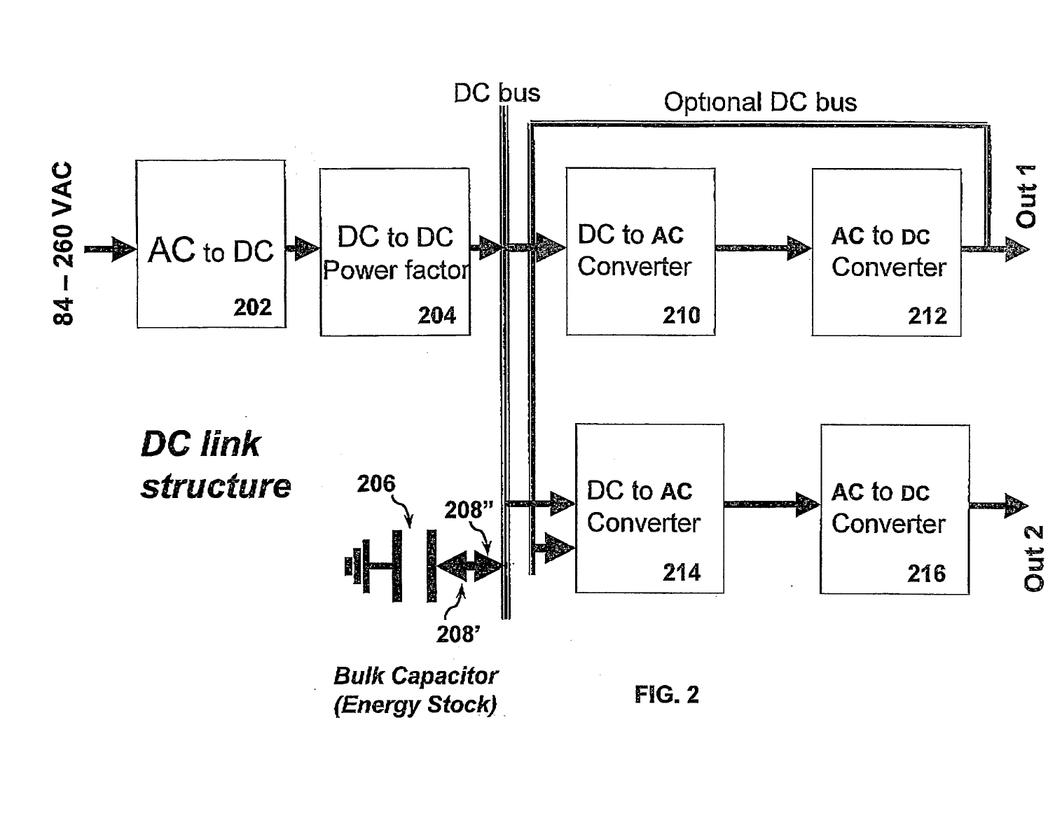

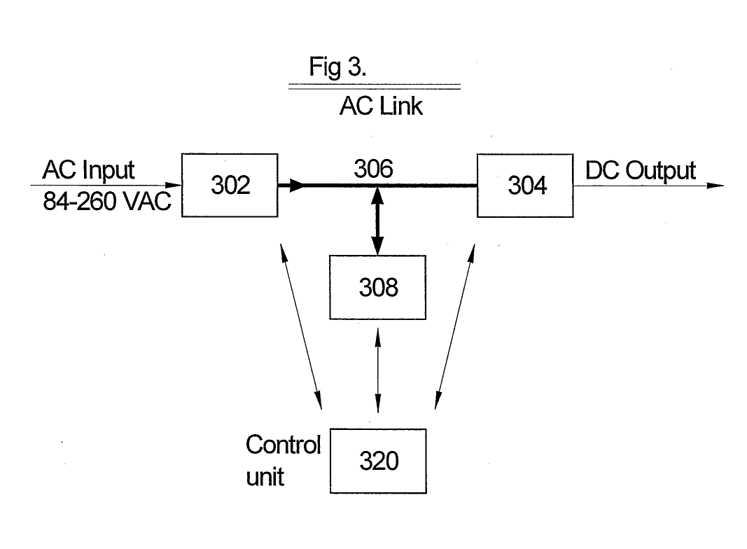

FIG. 3 shows a preferred embodiment of a power conversion architecture 300 according to the present invention. Architecture 300 comprises an input stage 302 that receives the same AC input as stage 102 in FIG. 1, stage 302 connected directly to an output stage 304 (that has at least one DC output) through an AC link 306. An energy storage device 308 is coupled (connected) to input stage 302 and output stage 304 through the AC link, in contrast with the prior art as embodied in FIGS. 1 and 2, where the energy storage component is linked to these stages through a DC link. The architecture further comprises a control module 320 that communicates (electrically, in a wired or wireless way) with each of the elements 302, 306 and 308. The communication is generally bi-directional (transmitting instructions to the elements and receiving information from the elements), except that the communication with the energy storage component may be uni-directional (receiving information only from component 308).

Advantageously, the energy storage device handles only part of the total energy, which results in smaller losses (higher efficiency), smaller physical size and consequently lower system price.

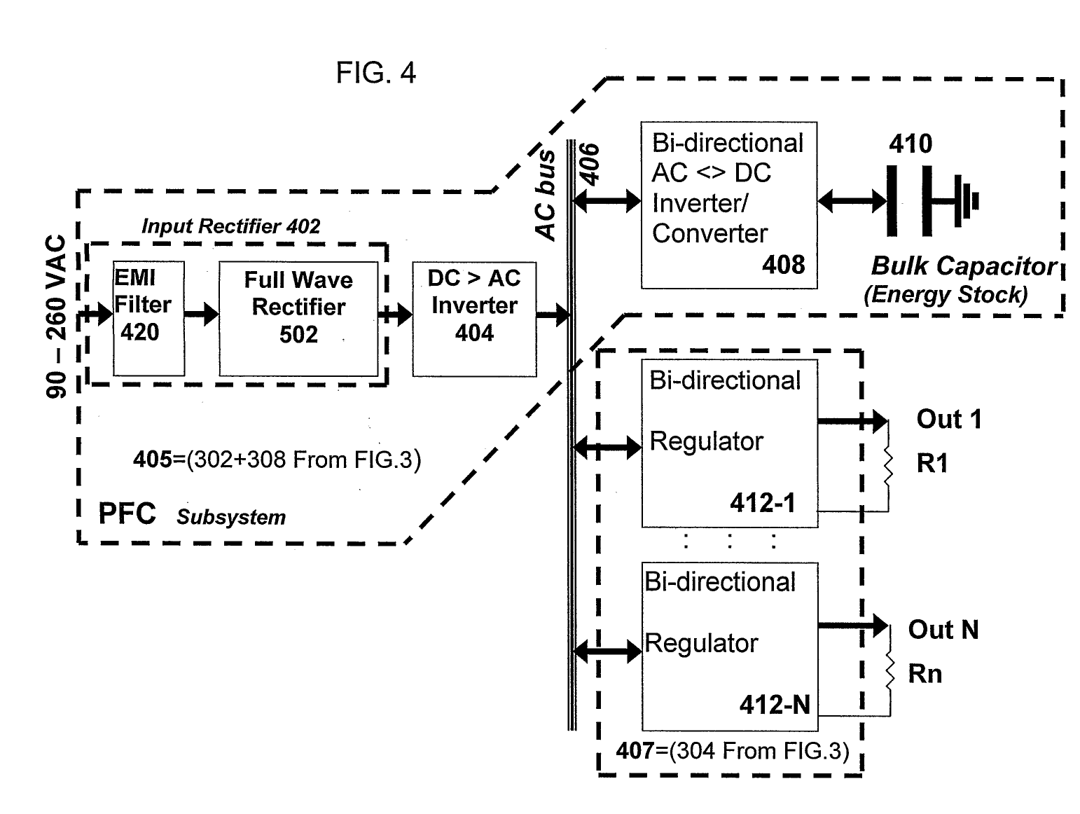

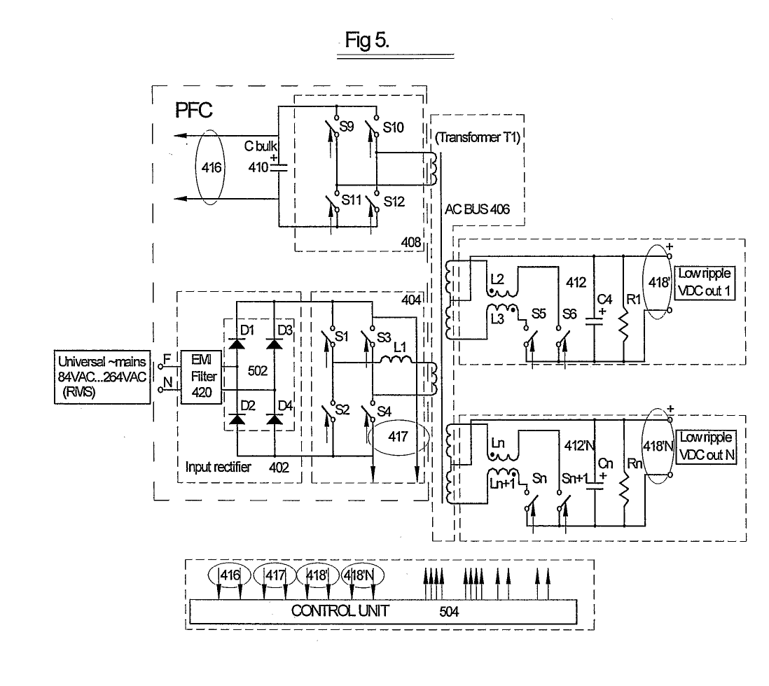

FIG. 4 shows in more detail a power conversion architecture 400 of the present invention, which gives more details of the architecture shown in FIG. 3. In architecture 400, the input stage 302 of FIG. 3 is embodied by an electromagnetic interference (EMI) filter 401, coupled electrically to an input rectifier (preferably a full wave AC-to-DC rectifier) 402, which is further coupled electrically to a DC-to-AC inverter 404. Architecture 400 further comprises an AC bus 406 identical with AC link 306 in FIG. 3, an energy storage device embodied by a bidirectional AC<>DC inverter/converter 408 coupled to an energy storage component (bulk capacitor or quick charge/discharge battery) 410, and an output stage 407 comprised of N bi-directional regulators (asynchronous or synchronous rectifiers/regulators) 412-1 to 412-N. The input stage and the energy storage device, i.e. units 401, 402, 404, 408 and 410, cooperatively form a power factor correction (PFC) sub-system 405. Advantageously, and in contrast with prior art, PFC 405 performs the power factor corrections without use of a dedicated unit, using instead existing functionalities of the DC/AC inverter, the energy storage device, and a controller 504 (see FIG. 5). Moreover, the PFC is performed using an AC link between the different units.

Each 412 regulator 412 outputs the required DC stabilized output voltage at a DC output “Out” connected to a load R. Exemplarily, for regulator 412-1, Out 1 is connected to a load R1 representing a first customer and for regulator 412-N, Out N is connected to a load Rn representing an n^{th} customer. Any number of additional parallel customers may be added without affecting the overall conversion efficiency of the system. Bi-directional DC<>AC inverters/converters are known in the art, see for example the “Full bridge inverter” plus “Resonant network” elements in FIG. 2 of “A low frequency AC to high frequency AC inverter with built-in power factor correction and soft switching” by W. Guo and P. K. Jain, IEEE Trans. Power Electron., Vol. 19, pp. 430-442, 2004, which is incorporated herein by reference. The control module (320 in FIG. 3) exists here as well but is not shown.

With reference to FIG. 4, in use, an AC input voltage, exemplarily a universal line voltage (84-260 VAC, 50-60 Hz) is fed through EMI filter 401 to input full wave rectifier (AC-to-DC) 402 and is converted therein into a rough DC current. The rough DC current exits rectifier 402 and is fed into DC-to-AC converter 404 where it is converted into a HF AC current. The HF AC current is now split at AC bus 406 to bidirectional AC<>DC inverter/converter 408 and to the N asynchronous rectifiers/regulators 412-1 to 412-N. The split depends on the instantaneous power available at the AC input. Exemplarily, customer 1, represented by Out 1, requires constant power. If the power supplied to it from AC bus 406 is greater that his requirement, the excess power is directed to the energy storage device (e.g. capacitor 410). If the power supplied to customer 1 from AC bus 406 is smaller than required, capacitor 410 provides converter 408 with the needed power difference, which is then transferred to Out 1 to satisfy the constant energy requirement. Capacitor 410 (or a quick charge/discharge battery) thus serves as an energy balancer, and the power transfer between it and the input and output stages occurs through the AC bus. Note that the energy storage device only receives power from the input stage, while it exchanges power bi-directionally with the output stage.

In general terms, when the input power is less than the required output power, the energy storage device is coupled only to the DC output stage. When the input power is equal to the power requirements at the DC output, the architecture enables a direct transfer of all power exiting the input stage to the output stage in an AC form. When the input power is greater then the required output power, the energy storage device receives the excess power from the input stage. The architecture thus provides much higher overall conversion efficiency, and maintains power factor correction (PFC) industry requirements. The topology is suitable also for un-interruptable power supplies and motor control systems.

FIG. 5 shows a detailed circuit implementation of the architecture of FIG. 4. The AC input is filtered via an EMI filter 420. Input rectifier 402 of FIG. 4 is implemented here using a full bridge 502 comprising four rectifier diodes D1, D2, D3 and D4 and input filter 420. The AC input voltage is indicated as coupled on the output to DC-to-AC converter 404 (FIG. 4), which is implemented by a circuit comprising switches (e.g. transistors) S1, S2, S3 and S4 and an inductor L1. Regulator 412-1 is implemented by a circuit comprising switches S5, S6, and a capacitor C4 connected to an output load R₁ providing a DC voltage VDC out 1 as shown. L2 and L3 are differential mode chokes that allow output voltage regulation by means of a phase shift between S5 and S6. Regulator 412-N is implemented by switches Sn and Sn+1, a capacitor Cn, and inductors Ln and Ln+1. connected to an output and load Rn providing a DC voltage VDC out N as shown. The DC outputs (VDC out 1 and VDC out N) are connected in parallel to AC bus 406 (transformer T1). Bi-directional AC<>DC inverter/converter 408 is implemented by a circuit comprising switches S9, S10, S11 and S12, and is shown connected to a bulk capacitor C_{bulk} 410. Each unit in the output stage is connected to AC bus 406 through isolated magnetic couplings. Control unit 504 (similar to 320 in FIG. 3) is coupled to the input and output stages and to capacitor C_{bulk}, as shown. The arrows exiting the control unit indicate its control over the various units, and those entering the control unit show inputs obtained at points 416, 417, and 418′-418N. The control unit controls the opening and closing of all the switches from S1 to Sn+1.

As shown in FIG. 5, first or second order pulse shaping networks are used in the power main stream as defined by 408 plus 410. Advantageously, there is no uncontrolled energy flow, no uncontrolled input inrush currents and no extra hardware needed to limit them. The pulse-by-pulse control enables use of smaller capacitors, thus simplifying the hot swap.

In summary, the present invention discloses a conversion architecture that has a number of advantages over prior art architectures:

1) No requirement for inrush current suppression. There is no capacitor connected in parallel to the input stage, so that upon an initial turn on (time t=0), the input voltage is nominal and the input current is almost zero. This is because of the bidirectional construction of the power supply, which dictates at t=0 almost zero input current, due to it being proportional to the output voltage which is also zero at t=0. In practical terms, due to the fact that the output energy is transferred from AC through an inductor, all the inrush current is limited by this inductor.

2) No requirement for dedicated output protection: The maximum output current is regulated (fixed) by the control unit. As a result of this construction, the internal supply dissipation is almost independent of the output load resistance. Therefore, the supply can operate under overload up to a short circuit condition for an unlimited time period. In effect the supply output operates as a current source. As a feature of the bidirectional nature of the construction, the input of the supply operates in a similar manner (current sink). At t=0, the output power is zero due to the charging of the energy storage component.

3) No loss of efficiency with multiple outputs. The topology allows multiple outputs to be realized with no loss of efficiency, because there are no additional conversion stages. All outputs are drawn in parallel from a single transformer. From an efficiency standpoint it is preferable to distribute the output power over a large number of outputs, as this will reduce the current from a single output.

An example is a “blade” server system application where each printed circuit board (or blade) is in essence a stand alone computer connected to the power supply via a common back-plane. By utilizing the primary side on the physical power supply and the secondary side at the load utilizing low voltage AC on the blade itself, it is possible to achieve a very high efficiency between the AC power input to the DC isolated very low voltage point of load output. Simulations (not shown) indicate that this provides between 10-12% overall efficiency improvement.

All publications and patents mentioned in this specification are herein incorporated in their entirety by reference into the specification, to the same extent as if each individual publication or patent was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. What has been described above is merely illustrative of the application of the principles of the present invention. Those skilled in the art can implement other arrangements and methods without departing from the spirit and scope of the present invention.

What is claimed is:

1. An alternating current (AC) to direct current (DC) high efficiency conversion architecture comprising:
a. an input stage operative to receive an instantaneous AC input and to output a high frequency (HF) AC output;
b. a DC output stage operative to receive said HF AC output through an AC link and to provide at least one customer with a required DC power at a respective DC output; and
c. an energy storage device coupled to both said input and output stages stage through said AC link and operative to correct any imbalance between a changing power availability at said instantaneous AC input and a constant power requirement of said at least one customer;
whereby the architecture enables a direct transfer of all power exiting said input stage to said output stage in an AC form, thereby providing a much higher overall conversion efficiency.

2. The conversion architecture of claim 1, further comprising a control unit coupled to said input stage, to said DC output stage and to said energy storage device and used for power factor correction, energy balancing for efficiency optimization, and for regulation of said DC output.

3. The conversion architecture of claim 1, wherein said input stage includes an electromagnetic interference (EMI) filter coupled electrically to an input full wave AC-to-DC rectifier, said rectifier further coupled electrically to a DC-to-AC inverter.

4. The conversion architecture of claim 1, wherein said energy storage device includes a bidirectional AC<>DC inverter/converter and an energy storage component.

5. The conversion architecture of claim 4, wherein said energy storage component is selected from the group consisting of a capacitor and a quick charge/discharge battery.

6. The conversion architecture of claim 1, wherein said DC output stage includes a plurality of regulators connected in parallel to said AC link, each said rectifier/regulator further connected to a respective said customer.

7. The conversion architecture of claim 1, wherein said coupling of said energy storage device to said input stage is unidirectional from said input stage to said energy storage device.

8. An alternating current (AC) to direct current (DC) high efficiency conversion architecture comprising:
a. an input stage coupled to a DC output stage through an AC bus;
b. an energy balancer operative coupled to said input and output stages through said AC bus and operative to regulate power allocation and transfer between an instantaneous AC power input to said input stage and a converted DC power output to a customer at said output stage; and
c. a control unit coupled to said input stage, to said DC output stage and to said energy balancer and used for controlling the operation of said input and output stages and said energy balancer.

9. The conversion architecture of claim 8, wherein said input stage includes an electromagnetic interference (EMI) filter coupled electrically to an input full wave AC-to-DC rectifier, said rectifier further coupled electrically to a DC-to-AC inverter.

10. The conversion architecture of claim 8, wherein energy balancer includes a bi-directional AC<>DC inverter/converter coupled bi-directionally to an energy storage component.

11. The conversion architecture of claim 10, wherein said energy storage component is selected from the group consisting of a capacitor or a quick charge/discharge battery.

12. The conversion architecture of claim 8, wherein said DC output stage includes a plurality of regulators connected in parallel to said AC bus, each said rectifier/regulator connected to a respective said customer.

13. The conversion architecture of claim 8, wherein said coupling of said energy balancer to said AC input stage is unidirectional from said input stage to said energy balancer.

14. A method for efficient conversion of alternating current (AC) power to direct current (DC) power, comprising the steps of:
inputting an instantaneous AC power to an input stage which outputs a high frequency (HF) AC voltage;
transferring said HF AC voltage through an AC link to a DC output stage operative to output a required DC power to at least one customer; and
using an energy storage device coupled to both said input stage and said DC output stage through said AC link to correct any imbalance between said required DC power and said instantaneous AC power

15. The method of claim 14, wherein said step of using an energy storage device to correct any imbalance includes having said energy storage device supply power to said DC output stage when said input power is smaller than said required DC power.

16. The method of claim 14, wherein said wherein said step of using an energy storage device to correct any imbalance includes having said energy storage device allow a direct transfer of all power exiting said input stage to said output stage in an AC form, when said input power is equal to said required DC power.

17. The method of claim 14, wherein said wherein said wherein said step of using an energy storage device to correct any imbalance includes having said energy storage device receive excess power from said input stage, when said input power is greater than said required DC power.

18. In an alternating current (AC) to direct current (DC) converter, a power factor correction subsystem comprising:
a. an input stage operative to receive an instantaneous AC power and to output a high frequency AC voltage; and
b. an energy storage device coupled to said input stage through an AC bus and operative to regulate power allocation and transfer between an instantaneous AC power input to said input stage and a converted DC power output to a customer at an output stage,
whereby the power factor correction in the AC-to-DC converter is performed using said AC bus.

19. The PFC subsystem of claim 18, wherein said input stage includes an electromagnetic interference filter coupled electrically to an input full wave AC-to-DC rectifier, said rectifier further coupled electrically to a DC-to-AC inverter.

20. The PFC subsystem of claim 18, wherein said energy storage device includes a bi-directional AC<>DC inverter/converter and an energy storage component.
